(19) United States
(12) Patent Application Publication
(10) Pub. No.: US 2025/0113296 A1
(43) Pub. Date: Apr. 3, 2025

(54) METHOD OF SELECTING AN ACCESS POINT FOR THE STATION IN A WIRELESS MESH NETWORK

(71) Applicant: VIETTEL GROUP, Ha Noi City (VN)

(72) Inventors: DANG CHUNG DUC NGUYEN, Ha Noi City (VN); VAN PHUONG DO, Ha Noi City (VN); THANH DUONG NGUYEN, Ha Noi City (VN); MINH THANG TRAN, Ha Noi City (VN)

(73) Assignee: VIETTEL GROUP, Ha Noi City (VN)

(21) Appl. No.: 18/899,815

(22) Filed: Sep. 27, 2024

(30) Foreign Application Priority Data
Oct. 3, 2023 (VN) 1-2023-06881

(51) Int. Cl. H04W 48/20; H04W 24/08; H04W 84/18

(52) U.S. Cl. CPC H04W 48/20; H04W 24/08; H04W 84/18

(57) ABSTRACT

An algorithm for selecting a new suitable AP for STAs in a mesh network and a method for exchanging data between APs built according to the IEEE 1905.1 standard. The active search helps reduce the latency when STAs move in the coverage area of the mesh network, ensuring service performance and maintaining stable connections. The vender message are specifically defined to ensure that the roaming process is not interrupted and that the service remains stable during the transition.

### TECHNICAL FIELD OF THE INVENTION

The invention relates to selecting an access point method for the station (STA) transition procedure in a wireless mesh network, specifically referring to the selection algorithm and data exchange between the access points in a local wireless network.

### STATE OF THE ART OF THE INVENTION

Currently, roaming solutions in mesh Wi-Fi networks rely solely on 802.11k and 802.11v messages, largely depending on STA. These solutions lack network control, leading to a low success rate, which degrades service quality and stability. Therefore, this method defines additional messages based on the IEEE 1905.1 standard to control the roaming process of STA, helping to increase the success rate, ensure stable connections and avoid the issue of ping pong STA connections between access point (APs).

### BACKGROUND OF THE INVENTION

A wireless mesh network is a system of access points (APs) that link together, usually wireless connections (Wi-Fi) or wired connections (Ethernet). A wireless mesh network aims to enhance coverage, ensure a quality connection, and simplify deployment.

A wireless mesh network may comprise numerous devices but consists of two types of logical entities: one wireless mesh Controller (Controller) and one or more wireless mesh Agents (Agent). The Controller implements the logic for controlling the fronthaul APs and backhaul links in the wireless mesh network. Additionally, the Controller provides onboarding functionality and provides wireless mesh devices to the network. An Agent executes commands received from the Controller, reporting measurements and capabilities data for fronthaul APs, clients, and backhaul links to a Controller or other Agents, as shown in FIG. 1 and FIG. 2.

One of the main advantages of the mesh network is capacity permits stations to discover and transition between APs in the network. This term is normally called roaming, steering, or BSS transition; external APs in the mesh network (the client isn't associating with) are called Neighbor APs. BSS transition management enables an AP to request non-AP STAs to transition to a specific AP, or to indicate to a non-AP STA a set of preferred APs, due to network load balancing or BSS Termination.

### BRIEF DESCRIPTION OF THE DRAWINGS

FIG. 1. Depicts the mesh network with wireless backhaul.

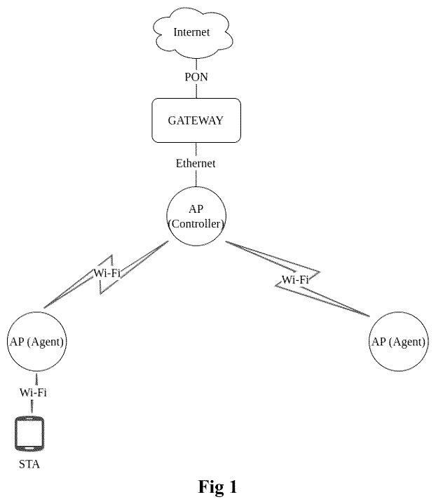

FIG. 2. Depicts the mesh network with LAN backhaul.

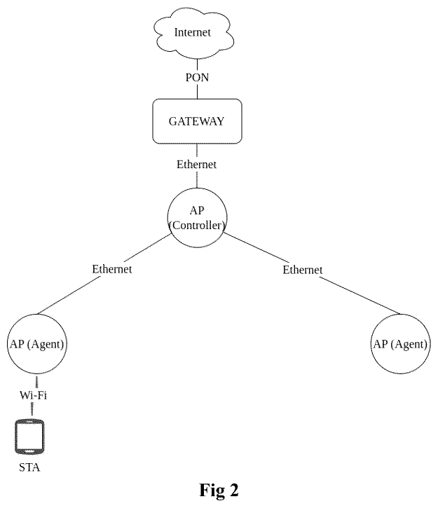

FIG. 3. Depicts the selection algorithm on the AP to find a new AP for STA to connect to.

FIG. 4. Depicts the flow of messages sent from this AP to the other AP that the STA needs to roam to from the time the roaming decision is considered until the STA successfully roams.

### DETAILED DESCRIPTION OF THE INVENTION

Step 1. The data of the STAs is updated periodically including the signal strength index, and data transmission speed with the wireless transmitter they are connected to in the mesh network. This data on the APs is regularly revised.

Step 2. Evaluate the connection status of an STA in the network to decide whether to perform roaming for that STA, whether to consider performing roaming for an STA is chosen according to the following formula:

$$x = Δ + \underline{x} \qquad ( 1 )$$

$$y = φ + \underline{y} on controller \qquad ( 2 )$$

$$y = ϕ + \underline{y} on agent$$

If x<y so, continue with step 3 to find a new AP for the STA connecting and vice versa, the STA still has a good enough connection to the current AP, so skip it and perform the assessment with another STA.

### Where:

x is the signal threshold parameter of STA
y is the signal strength threshold parameter defined to enable roaming for STA on the AP.
Δ is the signal strength parameter threshold on the transmission channel updated from the STA to the AP.
φ is the signal strength threshold that performs roaming on the controller. ϕ is the signal strength threshold that performs roaming on the agent.
x is the bandwidth-dependent noise of the transmission channel on the STA.
y is the bandwidth-dependent noise of the transmission channel on the AP.

If roaming is not required, return to step 1, in case the STA needs to roam, the AP that the STA is connected to will activate the mechanism to send a message requesting connection information from the device to other APs in the mesh network, the STA will send a response message containing connection information from this STA to other APs that it can scan for the AP that is connected to the STA. From there, there is data to search for a suitable coverage area for the device to roam.

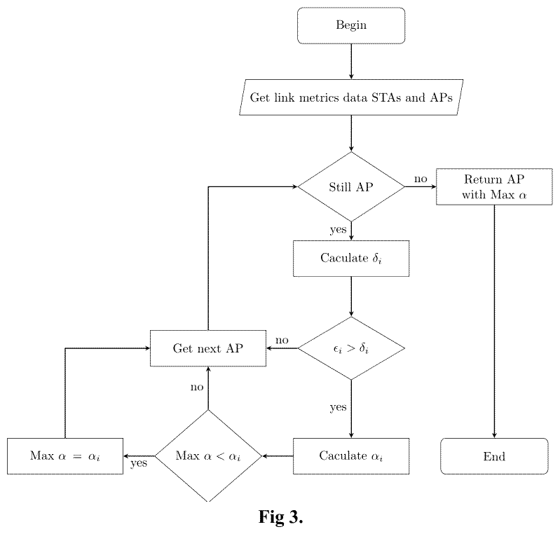

Step 3. After having information about the connection of the STA with other APs, perform the algorithm to find a new AP suitable for the STA, this algorithm is described in detail in FIG. 3.

Perform the search for a new coverage area for the roaming device based on the following formula:

$${δ}_{i} = {θ}_{i} + {β}_{i} \qquad ( 3 )$$

If εᵢ>δᵢ then ignore APᵢ

$${α}_{i} = {γ}_{i} - ( {ε}_{i} + {λ}_{i} ) with {τ}_{i} \neq 0 \qquad ( 4 )$$

$${α}_{i} = σ * ( {γ}_{i} - ( {ε}_{i} + {λ}_{i} ) ) with {τ}_{i} = 0$$

The maximum value a will correspond to the most suitable AP for connecting STA.

### Where:

θᵢ is the correlation coefficient APᵢ with the AP of the connected STA.
βᵢ is the bandwidth-dependent noise of the transmission channel APᵢ.
γᵢ is the signal strength APᵢ compared with the current AP.
εᵢ is the signal strength STA compared with the current AP.
λᵢ is the minimum signal strength to maintain a stable connection between two APs.
τᵢ is the correlation coefficient between the ranks of APs in the mesh network, APs with the same rank are equal to 0.
σ is the roaming coefficient between APs of the same class.

The AP that the STA is connected to will run its neighboring AP selection algorithm to move the STA to one of the neighboring APs in the mesh network. Firstly, the data related to the signal strength between the APs is evaluated, if the APs under consideration give a lower signal strength than the current AP, it will be ignored and the next AP will be considered. If the AP under consideration gives a better signal strength, calculate the value of the AP according to the formula defined in (4) and find the largest value among these APs.

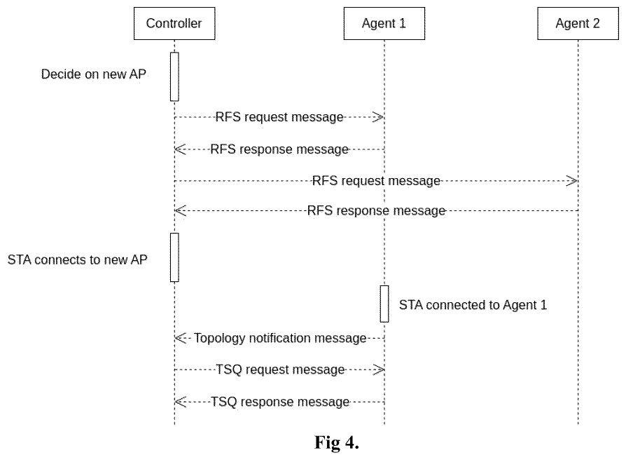

Step 4. When the AP finds a new AP for the STA to perform connecting, it will send a Request for Steering (RFS Request) message to the AP containing the destination coverage area that the STA will connect to. The message flow model in steps 4 and step 5 is described in FIG. 4, and the detailed content of this message is described in Table 1, message content (RFS Request).

TABLE 1
RFS Request Message Information

| Field | Length | Value Range | Description |
|---|---|---|---|
| Message ID | 1 | 1-255 | Message ID |
| MAC address | 6 | Any EUI-48 | MAC address of STA |
| | | value | |
| Time to disconnect | 4 | 0x00 | Time to disconnect of STA |
| Type of roaming | 1 | 0x01/0x02/0x03 | Type of roaming |
| Status | 1 | 0x00 | Status of AP |
| Number of AP | 1 | 1-255 | Number of AP |

When the AP receives this message (RFS Request), the AP will send back a roaming response message (RFS Response) to respond to whether to allow the STA to connect to its AP or not. If allowed, the STA will be activated to roam, and vice versa, this roaming request will be ignored, the detailed content of the message (RFS Response) is described in Table 2, message content (RFS Response).

TABLE 2
RFS Response Message Information

| Field | Length | Value Range | Description |
|---|---|---|---|
| Message ID | 1 | 1-255 | Message ID |
| MAC address | 6 | Any EUI-48 | MAC address of STA |
| | | value | |
| Status | 1 | 0x00 | Status of AP |
| Time to disconnect | 4 | 0-2147483647 | Time to disconnect of STA |
| Time to exhibit | 4 | 0-2147483647 | Time to exhibit STA |
| Number of | 1 | 1-255 | Number of roaming failed |
| roaming failed | | | |

Step 5. After the AP receives the RFS Response message approving the device's roaming, the transmitter will send a BSS Transition Management (BTM) message to the device to request a connection transfer to a new coverage area, the BTM Request message provides information to the client device about the AP that can support it to roam to.

When the device receives this BTM message, the STA will connect to the new AP, which is requested to connect. The STA will send back a BTM Response message to report whether the roaming process is successful or not. If the time limit expires and this BTM Response message is not received, the AP will resend the BTM message, the details of the BTM Response message.

When receiving a notification message of a new STA from the transmitter to which the device has roamed, the AP connected to the previous device will send a request message to end the roaming process (Teardown Steering Request, TSQ Request) to the AP to which the device has roamed; the details of the notification message of a new STA are described in Table 3 of the content of the notification message of a new connected STA. If the time limit has passed and the response message (TSQ Response) is not received, the AP will resend the TSQ Request. When the AP receives the (TSQ Response), the roaming process for the device will end. The details of the message (TSQ Response) are described in Table 4, and the content of the message (TSQ Response).

TABLE 3
TSQ Request Message Information

| Field | Length | Value Range | Description |
|---|---|---|---|
| Message ID | 1 | 1-255 | Message ID |
| MAC address | 6 | Any EUI-48 value | MAC address of AP |
| Reason | 1 | 0x00/0x01/0x02 | Reason of termination |

TABLE 4
TSQ Response Message Information

| Field | Length | Value Range | Description |
|---|---|---|---|
| Message ID | 1 | 1-255 | Message ID |
| MAC address | 6 | Any EUI-48 value | MAC address of AP |

### Implementation Example of the Invention

The method has been deployed on home Wi-Fi access points manufactured by Viettel High Technology Industries Corporation (VHT, branch of Viettel Group). The solution allows STAs to still stable connection to AP when mobility in the mesh network.

Here is an example of steps when deploying VHT APs.

For Users Preferring LAN for Backhaul Links:
1. Set up APs at the desired positions, including Controller and Agent.
2. Power up and connect them with Ethernet cables
3. VHT APs will LED indicators to signal the process is completed.
4. STA connects to the SSID of the mesh network.
5. STA uses internet service while moving in the mesh network.

### For Users Preferring Wireless for Backhaul Links:

1. Set up APs at the desired positions, including Controller and Agent.
2. Power up and connect them with the WPS button.
3. VHT APs will LED indicators to signal the process is completed.
4. STA connects to the SSID of the mesh network.
5. STA uses internet service while moving in the mesh network.

### Impact of the Invention

A comparison between the old solution and the new solution of this invention shows that the new solution brings several benefits, as depicted in the bellow tables.

| Aspect | Old solution | Proposed solution |
|---|---|---|
| Delay service | time-consuming | time-saving |
| Risk of Errors | Prone to STA | Reduce errors caused by |
| | | STA |
| Ability to automate | Manual of STA | Automatic of AP |

1. A method of selecting an access point for the STA in a wireless mesh network, comprising:
step 1: data of the STAs is updated periodically including a signal strength index, and data transmission speed with a wireless transmitter they are connected to in the mesh network, this data on the APs is regularly revised;
step 2: evaluate a connection status of an STA in the wireless mesh network to decide whether to perform roaming for that STA, whether to consider performing roaming for an STA is chosen according to the following formula:
$$x = Δ + \underline{x} \qquad ( 1 )$$
$$y = φ + \underline{y} on controller \qquad ( 2 )$$
$$y = ϕ + \underline{y} on agent$$
If x<y so, continue with step 3 to find a new AP for the STA connecting and vice versa, the STA still has a good enough connection to the current AP, so skip it and perform the assessment with another STA;
Where:
x is a signal threshold parameter of STA;
y is a signal strength threshold parameter defined to enable roaming for STA on the AP;
Δ is a signal strength parameter threshold on a transmission channel updated from the STA to the AP;
φ is the signal strength threshold that performs roaming on the controller;
ϕ is the signal strength threshold that performs roaming on the agent;
x is the bandwidth-dependent noise of the transmission channel on the STA;
y is the bandwidth-dependent noise of the transmission channel on the AP;
if roaming is not required, return to step 1, in case the STA needs to roam, the AP that the STA is connected to will activate a mechanism to send a message requesting connection information from a device to other APs in the mesh network, the STA will send a response message containing connection information from this STA to other APs that it can scan for the AP that is connected to the STA, from there, there is data to search for a suitable coverage area for the device to roam;
step 3: after having information about the connection of the STA with other APs, perform an algorithm to find a new AP suitable for the STA;
perform a search for a new coverage area for the roaming device based on the following formula:
$${δ}_{i} = {θ}_{i} + {β}_{i} \qquad ( 3 )$$
If εᵢ>δᵢ then ignore APᵢ
$${α}_{i} = {γ}_{i} - ( {ε}_{i} + {λ}_{i} ) with {τ}_{i} \neq 0 \qquad ( 4 )$$
$${α}_{i} = σ * ( {γ}_{i} - ( {ε}_{i} + {λ}_{i} ) ) with {τ}_{i} = 0$$
the maximum value a will correspond to the most suitable AP for connecting STA;
Where:
θᵢ is the correlation coefficient APᵢ with the AP of the connected STA;
βᵢ is a bandwidth-dependent noise of the transmission channel APᵢ;
γᵢ is the signal strength APᵢ compared with the current AP;
εᵢ is the signal strength STA compared with the current AP;
Δᵢ is the minimum signal strength to maintain a stable connection between two APs;
τᵢ is the correlation coefficient between the ranks of APs in the mesh network, APs with a same rank are equal to 0;
σ is a roaming coefficient between APs of the same class;
the AP that the STA is connected to will run its neighboring AP selection algorithm to move the STA to one of the neighboring APs in the mesh network, firstly, data related to the signal strength between the APs is evaluated, if the APs under consideration give a lower signal strength than the current AP, it will be ignored and the next AP will be considered, if the AP under consideration gives a better signal strength, calculate the value of the AP according to the formula defined in (4) and find the largest value among these APs;
step 4: when the AP finds a new AP for the STA to perform connecting, it will send a Request for Steering (RFS Request) message to the AP containing a destination coverage area that the STA will connect to, the detailed content of this message is described in Table 1, message content (RFS Request):
TABLE 1
RFS Request Message Information

| Field | Length | Value Range | Description |
|---|---|---|---|
| Message ID | 1 | 1-255 | Message ID |
| MAC address | 6 | Any EUI-48 | MAC address of STA |
| | | value | |
| Time to disconnect | 4 | 0x00 | Time to disconnect of STA |
| Type of roaming | 1 | 0x01/0x02/0x03 | Type of roaming |
| Status | 1 | 0x00 | Status of AP |
| Number of AP | 1 | 1-255 | Number of AP |

when the AP receives this message (RFS Request), the AP will send back a roaming response message (RFS Response) to respond to whether to allow the STA to connect to its AP or not; If allowed, the STA will be activated to roam, and vice versa, this roaming request will be ignored, the detailed content of the message (RFS Response) is described in Table 2, message content (RFS Response):
TABLE 2
RFS Response Message Information

| Field | Length | Value Range | Description |
|---|---|---|---|
| Message ID | 1 | 1-255 | Message ID |
| MAC address | 6 | Any EUI-48 value | MAC address of STA |
| Status | 1 | 0x00 | Status of AP |
| Time to disconnect | 4 | 0-2147483647 | Time to disconnect of STA |
| Time to exhibit | 4 | 0-2147483647 | Time to exhibit STA |
| Number of | 1 | 1-255 | Number of roaming failed |
| roaming failed | | | |

Step 5: after the AP receives the RFS Response message approving the device's roaming, the transmitter will send a BSS Transition Management (BTM) message to the device to request a connection transfer to a new coverage area, the BTM Request message provides information to the client device about the AP that can support it to roam to;
when the device receives this BTM message, the STA will connect to the new AP, which is requested to connect, The STA will send back a BTM Response message to report whether the roaming process is successful or not, If the time limit expires and this BTM Response message is not received, the AP will resend the BTM message, the details of the BTM Response message;
when receiving a notification message of a new STA from the transmitter to which the device has roamed, the AP connected to the previous device will send a request message to end the roaming process (Teardown Steering Request, TSQ Request) to the AP to which the device has roamed; the details of the notification message of a new STA are described in Table 3 of the content of the notification message of a new connected STA, if the time limit has passed and the response message (TSQ Response) is not received, the AP will resend the TSQ Request, when the AP receives the (TSQ Response), the roaming process for the device will end, the details of the message (TSQ Response) are described in Table 4, and the content of the message (TSQ Response):
TABLE 3
TSQ Request Message Information

| Field | Length | Value Range | Description |
|---|---|---|---|
| Message ID | 1 | 1-255 | Message ID |
| MAC address | 6 | Any EUI-48 value | MAC address of AP |
| Reason | 1 | 0x00/0x01/0x02 | Reason of termination |

TABLE 4
TSQ Response Message Information.

| Field | Length | Value Range | Description |
|---|---|---|---|
| Message ID | 1 | 1-255 | Message ID |
| MAC address | 6 | Any EUI-48 value | MAC address of AP |
